(19) United States
(12) Patent Application Publication
(10) Pub. No.: US 2010/0099545 A1
(43) Pub. Date: Apr. 22, 2010

(54) COMPRESSIBLE UNIT FOR A CENTRIFUGAL SEPARATOR

(75) Inventor: Kjell Klintenstedt, Saltsjo-boo (SE)

Correspondence Address: MICHAUD-Kinney Group LLP, 306 INDUSTRIAL PARK ROAD, SUITE 206, MIDDLETOWN, CT, 06457, US

(73) Assignee: ALFA LAVAL CORPORATE AB, Lund (SE)

(21) Appl. No.: 12/531,130

(22) PCT Filed: Mar. 3, 2008
(86) PCT No.: PCT/SE2008/000169

§ 371 Date: Oct. 16, 2009

(30) Foreign Application Priority Data
Mar. 14, 2007 (SE) 0700634-9

(51) Int. Cl. B04B 1/04

(52) U.S. Cl. 494/79

(57) ABSTRACT

In a compressible unit a plurality of separating discs are provided and adapted to being capable, in a compressed state, of being mounted in and removed from a centrifugal separator rotor, which rotor during operation is rotatable about an axis of rotation. The unit includes a support, a pressure surface, between which the separating discs are disposed abutting against one another. Guide surfaces abut against the separating discs and control radial and polar position. At least one compression mechanism is adapted during compression of the unit to press the support and pressure surface towards one another so that the discs are compressed. During compression, the guide surfaces allow relative movement between the support and pressure surface and the separating discs, and are of at least sufficient extent in the compression direction for the position-controlling abutment between the guide surfaces and the separating discs to be maintained throughout the relative movement during the compression.

### FIELD OF THE INVENTION

The present invention relates to a compressible unit comprising a plurality of separating discs and adapted to being capable, in a compressed state, of being mounted in a rotor of a centrifugal separator and being taken out of the rotor, which during operation with the unit mounted therein is rotatable about an axis of rotation. This unit comprises a support means and a pressure means, between which support and pressure means the separating discs are disposed abutting against one another. The unit further comprises a central control means provided with guide surfaces which abut against the separating discs and control the latter's radial and polar position, and at least one compression means adapted, during compression of the unit in a compression direction, to pressing the support and pressure means towards one another in such a way that the separating discs disposed between them are compressed.

### BACKGROUND OF THE INVENTION

Patent document SE 146 598 discloses a compressible unit, but the compression of the stacked separating discs is effected, after an insert has been moved down in the rotor body, by an expensive compression tool in a labour-intensive process.

U.S. Pat. No. 5,637,217 and WO 2004/020105 refer to examples of centrifugal separators provided with inserts of separating discs in the form of units which are held together and compressed by a plurality of rods or bolts through the disc set, thereby disturbing the flow through the disc set and hence the separation results. A large number of parts also have to be handled during assembly and disassembly, which are therefore labour-intensive operations.

### SUMMARY OF THE INVENTION

The object of the present invention is to propose a compressible unit which comprises a plurality of separating discs of the kind indicated above and is easy to assemble and disassemble outside the rotor of the centrifugal separator and easy to compress without any expensive compression tools.

Another object is to propose a compressible unit which is easy to replace, inspect and modify as the need arises.

A further object is to propose a compressible unit which can be balanced separately, making it easy to replace without having to rebalance the rotor of the centrifugal separator.

According to the present invention, guide surfaces are provided as part of a central control means in a compressible unit which comprises a plurality of separating discs of the kind indicated above being so configured that during compression they allow relative movement between the support and pressure means and the separating discs disposed between them, and being of at least sufficient extent in the compression direction for the position-controlling abutment between the guide surfaces and the separating discs to be maintained throughout the relative movement during the compression.

According to an embodiment of the invention, the compressible unit has in the compression direction an extent which is reduced by at least five percent during the compression.

According to another embodiment of the invention, the compressible unit has in the compression direction an extent which is reduced by at least ten percent during the compression.

According to a preferred embodiment of the invention, the unit is compressed in a compression direction which is parallel with the axis of rotation. In this context, the compression means is preferably disposed between at least one out of the support and pressure means and the control means, which latter in turn abuts against the other out of the support and pressure means via axially facing pressure-transmitting contact surfaces in such a way that during compression the control means together with the other out of the support and pressure means and the separating discs disposed between the support and pressure means is pressed towards the first out of the support and pressure means.

According to another embodiment of the invention, the unit also comprises an inlet chamber which is formed within the control means and which is provided a plurality of inlet discs for entraining during operation a liquid mixture of components which is to be separated.

According to still another embodiment of the invention, the unit also comprises an outlet chamber which is formed within the control means and which is connected to the radially outer region of the control means via at least one outlet passage disposed in the control means.

### BRIEF DESCRIPTION OF THE DRAWINGS

The invention is described below in more detail with reference to the attached drawings, in which

FIG. 1 depicts schematically a rotor of a centrifugal separator, which rotor is provided with a compressed unit in accordance with the present invention, in axial section, and

FIG. 2 depicts schematically an uncompressed unit in accordance with the present invention, in axial section, which is not mounted in a rotor of a centrifugal separator.

### DETAILED DESCRIPTION OF VARIOUS EMBODIMENTS OF THE INVENTION

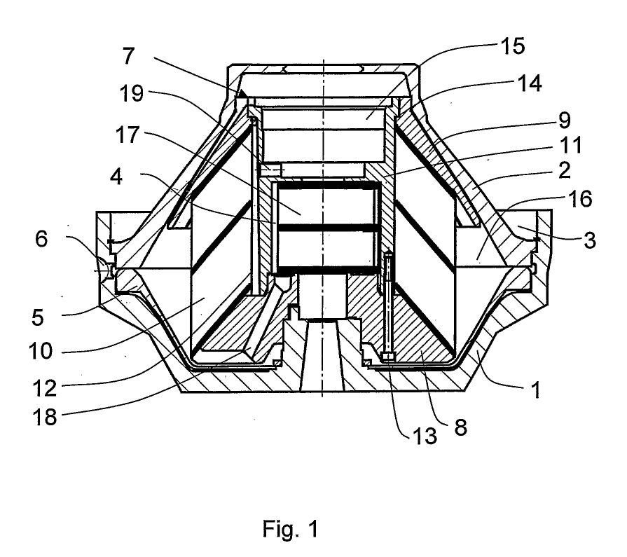

The rotor depicted in FIG. 1 has a lower element 1 and an upper element 2 which are held together by a locking ring 3. As a depicted example of many possible rotors which might be provided with a compressible unit according to the present invention, it is adapted to being mounted on a hollow drive shaft (not shown) through which the liquid mixture of components which is to be separated is supplied to a central inlet chamber 4 in the rotor. The rotor depicted is provided with an axial tubular valve slide 5 adapted to intermittently open and close a passage, closed in the drawing, between the inside of the rotor and outlet apertures 6 disposed in the lower element of the rotor.

Centrally in the rotor, a compressible unit 7 according to the present invention is disposed axially between the valve slide 5 and the upper element 2. The compressible unit has a support means 8, a pressure means 9 and, disposed between them, a stack of a plurality of truncated conical separating discs 10 which have between them intermediate spaces in which the main separation takes place during operation. The unit 7 is provided centrally with a control means 11 itself provided with a number of guide surfaces 12 which abut against the separating discs 10 and control the latter's radial and polar position at the radially inner edge of the separating discs. A compression means 13 is disposed between at least one out of the support and pressure means and the control means 11. In the example depicted, the compression means 13 takes the form of a screw disposed between the support means 8 and the control means 11. The control means 11 itself abuts against the other out of the support and pressure means, which in the example depicted is the pressure means 9, via axially facing pressure-transmitting contact surfaces 14 in such a way that during compression the control means 11 together with said other out of the support and pressure means and the separating discs 10 disposed between the support and pressure means are pressed against said one out of the support and pressure means.

In the unit depicted by way of example, an inlet chamber 4 and an outlet chamber 15 are formed centrally within the control means. In the inlet chamber 4 a plurality of inlet discs 17 are adapted to entraining, during operation, a liquid mixture of components which are to be separated, and the inlet chamber 4 communicates with a separating chamber 16 via a number of distribution ducts 18. The outlet chamber 15 communicates with the separating chamber 16 via at least one outlet passage 19 disposed in the control means.

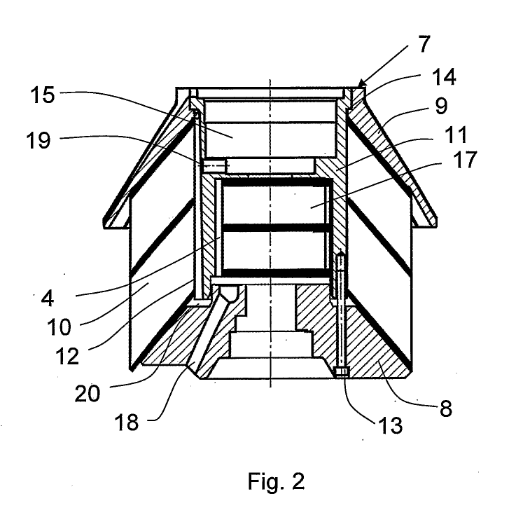

Since the unit depicted in FIG. 1 is mounted in the rotor, it is compressed. FIG. 2 depicts the same unit not mounted in a rotor and not compressed, as indicated by the axial distance 19 between the support means 8 and the control means 11.

In the example depicted, the separating discs are conical and compressed in a direction which is parallel with the axis of rotation, but it is also possible to apply the invention with conventional axial separating discs which are compressed in the circumferential direction.

Thanks to the present invention a compressible unit comprising a plurality of separating discs is accomplished which is easy to assemble and disassemble outside the rotor of the centrifugal separator, easy to compress without any expensive compression tools and easy to replace, inspect and modify as the need arises.

A compressible unit according to the present invention can also be balanced separately, making it possible for it to be replaced without having to rebalance the rotor of the centrifugal separator.

What is claimed is:

1-7. (canceled)

8. A compressible unit comprising a plurality of separating discs which when, in a compressed state, are mountable in a rotor of a centrifugal separator and can be taken out of the rotor, which rotor during operation with the unit mounted therein is rotatable about an axis of rotation,
support means,
a pressure means,
between which support and pressure means the separating discs are disposed abutting against one another,
central control means provided with guide surfaces which abut against the separating discs and control the latter's radial and polar position, and
at least one compression means adapted, during compression of the unit in a compression direction, to pressing the support and pressure means towards one another in such a way that the separating discs disposed between them are compressed, and wherein
during compression, the guide surfaces of the central control means allow relative movement between the support and pressure means and the separating discs disposed between them, and are of at least sufficient extent in the compression direction for the position-controlling abutment between the guide surfaces and the separating discs to be maintained throughout the relative movement during the compression.

9. A compressible unit according to claim 8, wherein, in the compression direction the compressible unit has an extent which is reduced by at least five percent during compression.

10. A compressible unit according to claim 8, wherein, in the compression direction the compressible unit has an extent which is reduced by at least ten percent during the compression.

11. A compressible unit according to claim 8 wherein the compression direction is substantially parallel with the axis of rotation.

12. A compressible unit according to claim 11, wherein the compression means is disposed between at least one out of the support and pressure means and the control means, which latter abuts against the other out of the support and pressure means via axially facing pressure-transmitting contact surfaces in such a way that during the compression the control means together with the other out of the support and control means and the separating discs disposed between the support and pressure means is pressed toward the first out of the support and pressure means.

13. A compressible unit according to claim 8, further comprising an inlet chamber which is formed within the control means and which is provided with a plurality of inlet discs for entraining during operation a liquid mixture of components which is to be separated.

14. A compressible unit according to claim 8, further comprising an outlet chamber which is connected to the radially outer region of the control means via at least one outlet passage disposed in the control means.
